(19) United States
(12) Patent Application Publication
(10) Pub. No.: US 2017/0108115 A1
(43) Pub. Date: Apr. 20, 2017

(54) SELECTOR DEVICE

(71) Applicant: ECS ENGINEERED CONTROL SYSTEM AG, St. Gallen (CH)

(72) Inventor: Heiko SCHIRMER, Regesbostel (DE)

(73) Assignee: ECS Engineered Control Systems AG, St. Gallen (CH)

(21) Appl. No.: 15/312,316

(22) PCT Filed: May 13, 2015
(86) PCT No.: PCT/EP2015/060650

§ 371 Date: Nov. 18, 2016

(30) Foreign Application Priority Data
May 20, 2014 (DE) 10 2014 107 077.1

(51) Int. Cl. F16H 59/02; F16H 59/10; F16H 59/04; F16H 61/22

(52) U.S. Cl. CPC F16H 59/0204; F16H 61/22; F16H 59/10; F16H 59/04; F16H 61/36

(57) ABSTRACT

A selector device for a motor vehicle transmission has an actuating lever (1) transferable into a first shift gate, in which it is coupled mechanically to a transmission component (2) for actuating a selector control cable (23), or into a second shift gate which is decoupled from the transmission component (2). The transmission component (2) is mounted movably, and a locking means (11) is configured as a spring element that is received in a locking receptacle (16) when the actuating lever (1) is situated in the second shift gate. The locking receptacle (16) has an end centering means (25), in which the locking means (11) is received with a shaped part (21) when the actuating lever (1) is situated in the second shift gate, and has a relieving centering means (26) which tapers conically. The shaped part (21) is configured to be received in a positively locking manner by the relieving centering means (26) during move out of the end centering means (25).

### CROSS-REFERENCE TO RELATED APPLICATIONS

This application is a national stage application (under 35 USC §371) of PCT/EP2015/060650, filed May 20, 2015, which claims benefit of German application No. 10 2014 107 077.1, filed May 20, 2014, the contents of each of which are incorporated by reference herein.

### BACKGROUND OF THE INVENTION

Technical Field and State of the Art

The present invention relates to a selector device for a motor vehicle transmission.

German patent application DE 10 2011 053 177 A1 discloses a selector device of the type described below with reference to FIGS. 1 and 2. This selector device has an actuating lever 1 that can be selectively shifted into a first shift gate, especially into an automatic shift gate, for example, in order to select one of the shift positions R, D, N, P, or else into a second shift gate, especially in order to select “+” to shift up or to select “−” to shift down.

In the detailed view shown in FIG. 1, the actuating lever 1 is in the first shift gate. In this position, the actuating lever 1 is mechanically coupled to a transmitting component 2. This is done in such a way that the transmitting component 2 can be pivoted by means of the actuating lever in order to actuate a control cable (not visible in this view) or a gearshift linkage. Pivoting in order to select one of several shift positions in the first shift gate is done by pivoting the actuating lever 1—and thus also the transmitting component 2—in a plane that is perpendicular to the drawing plane, namely, by pivoting around a pivot axis 3. For purposes of coupling a gearshift cable, the transmitting component 2 has a coupling point 4 that can only be partially seen in this figure.

In order to shift the actuating lever 1 into the second shift gate, the lever is pivoted around a shifting axis 5. The shifting axis 5 is arranged perpendicular to a plane in which the pivot axis 3 is located. Moreover, the shifting axis 5 is arranged above the pivot axis 3 as seen from the perspective of the operation of the actuating lever 1.

The actuating lever has a first projection 6 that engages into a first recess 7 of the transmitting component 2 when the actuating lever 1 is in the first shift gate. Furthermore, the actuating lever 1 has a second projection 8 that engages into a second recess 9 of the transmitting component 2 when the actuating lever 1 has been shifted into the first shift gate. This ensures that the transmitting component can be pivoted by means of the actuating lever in order to actuate the control cable or a gearshift linkage. When the actuating lever is in the first shift gate, the actuating lever 1 and the transmitting component 2 are supported so that they can pivot together around the same pivot axis 3. When the actuating lever 1 is shifted into the second shift gate, the transmitting component 2 is secured by means of a special locking means 11 relative to a selector frame 10 that is preferably stationary relative to a motor vehicle and that is only shown partially here, thereby eliminating the pivoting capability. When the actuating lever 1 is in the second shift gate, however, it can continue to be pivoted around the pivot axis 3, especially for purposes of shifting up or down manually.

The locking means 11 is configured as a spring element 12, namely, as a spring tongue. A first end 13 of the locking means 11 is firmly joined to the transmitting component 2. The opposite second end 14 of the locking means 11 ends freely and is held in a released position by an actuating projection 15 of the actuating lever 1 against a pre-tension stemming from the spring element 12.

As soon as the actuating lever 1 is shifted into the second shift gate, the actuating projection 15 moves away from the locking means 11 in such a way that the second end of the locking means 14 can engage into a locking receptacle 16 of the selector frame 10. In this manner, the capability of the transmitting component 2 to pivot around the pivot axis 3 is blocked.

FIG. 2 also clearly shows that the first projection 6 and the second projection 8 are disengaged from the recesses 7 and 9 when the actuating lever 1 has been shifted into the second shift gate. In this way, even though the transmitting component 2 is secured by the locking means 11, the actuating lever 1 can be pivoted around the pivot axis 3 for purposes of shifting up or down.

When the actuating lever 1 is shifted from the second shift gate back into the first shift gate, the actuating projection 15 pushes the locking means 11 out of the locking receptacle 16. At the same time, the projections 6 and 8 of the actuating lever 1 engage into the associated recesses 7 and 9 of the transmitting component 2 so that the gearshift cable or the gearshift linkage can once again be actuated by means of the actuating lever 1.

European patent application EP 2 261 535 A1 discloses a selector device for a motor vehicle transmission. However, a problematic aspect of such a selector device is that, when the actuating lever is in the second shift gate and the gearshift cable or the gearshift linkage of the control cable is uncoupled from the actuating lever, alternating load reactions can cause impacts that act on the gearshift cable and consequently on the transmitting component. These impacts can cause the locking means to become disengaged from the locking receptacle, so that the transmitting component is no longer secured in the locking receptacle and, in the worst case scenario, shifting can take place, even by means of the gearshift cable or the gearshift linkage.

It is an objective of the present invention to refine a selector device of the above-mentioned type so as to ensure that the functioning of the selector device is reliable and not failure-prone, especially when the actuating lever is in the second shift gate. Moreover, it is an objective of the invention to put forward such a transmission as well as such a motor vehicle in which it is ensured that the functioning of the selector device is reliable and not failure-prone, especially when the actuating lever is in the second shift gate.

### SUMMARY OF THE INVENTION

The selector device according to an embodiment of the invention for a motor vehicle transmission has an actuating lever that can be selectively shifted into a first shift gate in which the lever can be mechanically coupled to a transmitting component in order to actuate a gearshift cable or a gearshift linkage, or else it can be shifted into a second shift gate in which it is uncoupled from the transmitting component. Here, the transmitting component is movably supported, whereby furthermore, a locking means configured as a spring element is provided with which the transmitting component can be secured in such a way that it does not exert any force on the gearshift cable or on the gearshift linkage as long as the actuating lever has been shifted into the second shift gate, in other words, the gearshift cable or the gearshift linkage are thus without power. Here, the locking receptacle has an end centering means in which the locking means configured as a spring element, along with its molded part, is accommodated when the actuating lever is in the second shift gate, whereby the locking receptacle also has a relieving centering means. In this context, the locking means releases the transmitting component in that the actuating lever is shifted into the second shift gate, whereby the locking means is accommodated in a locking receptacle when the actuating lever is in the second shift gate. In order for the locking means to be securely held in the locking receptacle and for it to also remain there as long as the user does not shift the actuating lever into the first shift gate, the locking means—when the actuating lever is in the second shift gate—is subject to a restoring force that is oriented counter to the direction of movement of the locking means when the actuating lever is shifted from the second shift gate into the first shift gate.

Thanks to the configuration according to this embodiment of the invention, a selector device is now being put forward with which the locking means reliably remains in the locking receptacle, or else the locking means is immediately returned to a target position of the locking receptacle autonomously when an impact force is exerted onto the gearshift cable or onto the gearshift linkage, thereby moving the locking means out of the locking receptacle. As soon as the impact force, which only occurs punctually, is removed again from the gearshift cable or from the gearshift linkage, the locking means autonomously moves back into the locking receptacle due to the restoring force and due to the special geometric configuration of the locking receptacle with its end centering means and its relieving centering means. This ensures that the transmitting component is securely affixed when the actuating lever is in the second shift gate in which it is uncoupled from the transmitting component, whereby the locking means is securely held in the locking receptacle due to the restoring force that is acting on the locking means configured as a spring element and due to the special geometric configuration of the locking receptacle, and said locking means is repeatedly autonomously returned into the end centering means of the locking receptacle, which is configured as the target position for the locking means, even in case of impact forces exerted punctually by the gearshift cable. The special relieving centering means functions essentially in the manner of a catching contour that prevents the locking means from becoming completely detached from the locking receptacle. In fact, the inventive configuration of the selector device ensures that the locking means is repeatedly autonomously moved back into its target position in the end centering means as long as the actuating lever is in the second shift gate. Thus, no undesired autonomous shifting can be triggered by the transmitting component when impact forces act on the transmitting component via the gearshift cable or the gearshift linkage. Here, the actuating lever is held in the second shift gate so that the gears of the transmission can be shifted up or down by selecting “+” or “−” respectively. The user can shift the actuating lever from the second shift gate into the first shift gate by means of the selector device according to the invention, so that subsequently, the shift positions R, D, N, P can once again be selected by means of the actuating lever and the transmitting component that is mechanically coupled to it.

According to a first advantageous embodiment of the invention, the locking means configured as a spring element has a spring tongue onto whose free end the molded part is shaped, said shape corresponding to the shape of the locking receptacle in the area of the end centering means. Owing to such a configuration of the locking means with the spring tongue, it is easily possible to implement a restoring force. Here, the molded part can be shaped onto the free end of this spring tongue, said shape interacting with the shape of the locking receptacle in such a way that the molded part and the locking receptacle are connected to each other essentially with a positive fit, at least in some areas, especially in the area of the end centering means of the locking receptacle when the actuating lever is shifted from the first shift gate into the second shift gate. Such a connection of the molded part and of the locking receptacle also prevents the locking means from already moving out of the locking receptacle due to small impact forces that act on the gearshift cable or on the gearshift linkage. The restoring force of the spring tongue or of the locking means configured as a spring element is selected here in such a way that such a connection is established again, even if the impact forces acting on the gearshift cable or on the gearshift linkage are so high that the molded part and the locking receptacle have come out of their reciprocal connection, which has a positive fit, at least in certain areas.

Here, it has proven to be advantageous for the relieving centering means to extend conically towards the end centering means as well as conically away from the end centering means, whereby the cross section of the molded part is configured in such a way that, when it is moved out of the end centering means, it can be accommodated with a positive fit, at least in some areas, in the relieving centering means. Owing to this configuration of the relieving centering means, which can also be referred to as being essentially heart-shaped, it is especially ensured that the locking means or its molded part is not completely detached from the locking receptacle, but rather, that said locking means is caught in the relieving centering means and is again autonomously moved into the end centering means by the restoring force of the locking means configured as a spring element.

In this context, it has proven to be especially advantageous for the locking receptacle or the relieving centering means and/or the end centering means to have surfaces on which the molded part can be autonomously shifted into a target position by a restoring force that is directed towards the end centering means and that is exerted onto the locking means when the actuating lever is in the second shift gate. The target position here is meant to be seen as the position of the locking means in which the latter is accommodated in the locking receptacle in the end centering means and in which the actuating lever is in the second shift gate. This embodiment of the invention makes it possible for the locking means to be autonomously and compulsorily returned to the target position in the locking receptacle due to the restoring force along these surfaces when said locking means has come out of the locking receptacle due to impact forces acting on the gearshift cable or on the gearshift linkage. Advantageously, these surfaces converge conically, so that the molded part and thus the entire locking means with its corresponding surface can slide off due to the restoring force into a target position for the molded part when the molded part and thus the locking means have moved out of the locking receptacle due to the above-mentioned impact forces, and as long as the actuating lever is in the second shift gate.

According to another advantageous embodiment of the invention, the actuating lever has an actuating projection with which the locking means, along with its molded part, can be disengaged from the locking receptacle when the actuating lever is shifted from the second shift gate into the first shift gate. Owing to this configuration, it is easily possible without a great deal of technical resources to simultaneously disengage the molded part of the locking means from the locking receptacle when the actuating lever is actuated while it is being shifted from the second shift gate into the first shift gate, so that the transmitting component is detached from where it is affixed, in order to subsequently once again be mechanically coupled to the actuating lever, so that the transmitting component moves synchronously with the actuating lever again when the latter is in the first shift gate.

Here, on the one hand, it can be provided for the locking means to be arranged on the transmitting component and for the locking receptacle to be arranged on a selector frame or on a selector housing.

On the other hand, it can, of course, be provided for the locking means to be arranged on a selector frame or on a selector housing and for the locking receptacle to be arranged on the transmitting component.

Moreover, the gearshift cable or the gearshift linkage can advantageously be attached to the transmitting component in order to mechanically transmit shifting commands. For example, the transmitting component can have a coupling point for a gearshift cable or for a gearshift linkage.

Moreover, the transmitting component can advantageously have a first pivot arm and a second pivot arm, whereby the actuating lever is preferably arranged between the first pivot arm and the second pivot arm, and whereby the first pivot arm and the second pivot arm are preferably firmly connected to each other by means of a connecting piece. Owing to this configuration, it is easily possible to mechanically couple the actuating lever to the two pivot arms of the transmitting component by means of appropriate receptacles and corresponding projections that are present on the actuating lever. This ensures an especially synchronous and smooth actuation of the actuating lever in the first shift gate since the transmitting component is coupled to the actuating lever on both sides thereof, as a result of which no shear forces occur between the actuating lever and the transmitting component.

Advantageously, the capability of the transmitting component to move, especially its capability to pivot, is blocked when the actuating lever has been shifted into the second shift gate, and the capability of the transmitting component to move, especially its capability to pivot, is made possible when the actuating lever has been shifted into the first shift gate. Owing to this configuration, the transmitting component can only be moved or pivoted when the actuating lever is in the first shift gate.

A transmission, particularly an automatic transmission for a motor vehicle that is equipped with a selector device according to the invention, is especially advantageous.

By the same token, a motor vehicle that is equipped with such a transmission or with a selector device according to the invention is especially advantageous.

Additional objectives, advantages, features and application possibilities of the present invention can be gleaned from the description below of an embodiment making reference to the drawing. In this context, all of the described and/or depicted features, either on their own or in any meaningful combination, constitute the subject matter of the present invention, also irrespective of their compilation in the claims or in the claims to which they refer back.

### DESCRIPTION OF THE DRAWINGS

The following is shown:

FIG. 1 a detailed view of a selector device according to the state of the art, in which the actuating lever has been shifted into a first shift gate,

FIG. 2 a detailed view of a selector device according to the state of the art, in which the actuating lever has been shifted into a second shift gate,

FIG. 3 a detailed view of a selector device according to the invention, in which the actuating lever has been shifted into a second shift gate,

FIG. 4 another detailed view of the selector device according to the invention as depicted in FIG. 3, whereby additionally, the position of a locking means in which the actuating lever has been shifted into a first shift gate is shown, and

FIG. 5 a detailed view of a locking receptacle of a selector device according to the invention.

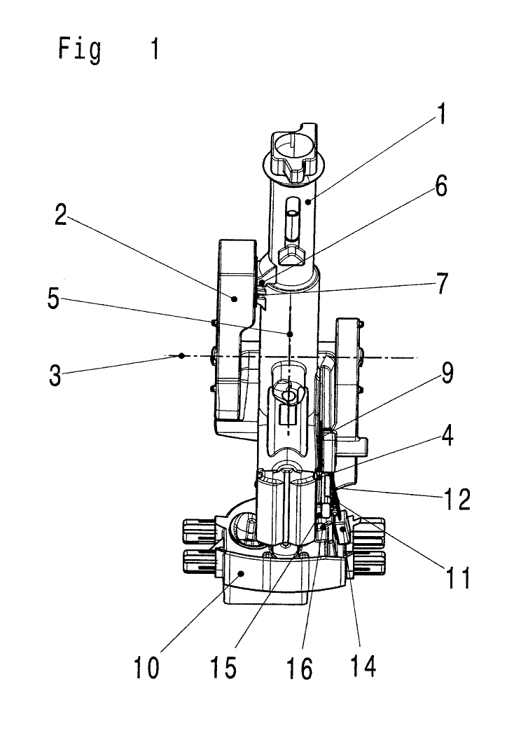

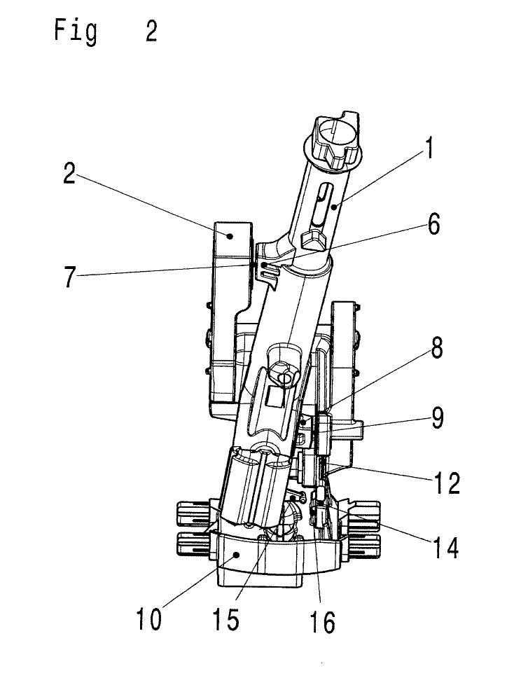

### DETAILED DESCRIPTION

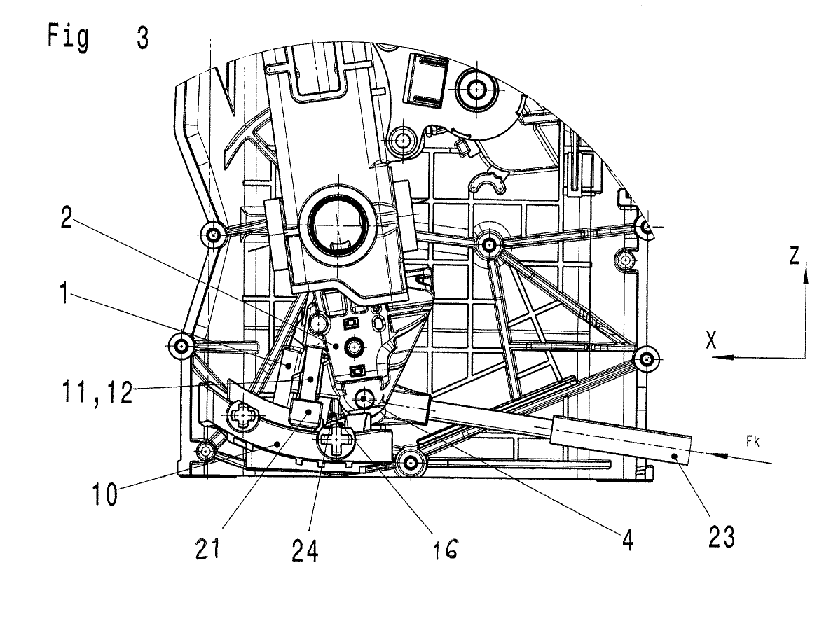

FIG. 3 shows an embodiment of a selector device according to the invention, in which an actuating lever 1 of the selector device has been shifted into a second shift gate. Aside from the actuating lever 1, the selector device also has a transmitting component 2 that is mechanically coupled to the actuating lever 1 when the latter is in a first shift gate. However, if the actuating lever 1 is in a second shift gate, then the transmitting component 2 is mechanically uncoupled from the actuating lever 1.

In the depiction shown in FIG. 3, as already mentioned above, the actuating lever 1 is in the first shift gate, so that the transmitting component 2 is mechanically uncoupled from the actuating lever 1. A locking means 11 which, in this case has a spring U-clamp 12 at whose free end a molded part 21 is arranged, is accommodated in a locking receptacle 16 when the actuating lever 1 is in the second shift gate.

Moreover, a coupling point 4 to which a gearshift cable 23 is coupled is arranged on the transmitting component 2. By means of the gearshift cable 23, the various transmission modes or shift positions R, D, N, P, can be selected on a transmission arranged at another end of the gearshift cable 23 by means of the actuating lever 1 when the actuating lever 1 is in the first shift gate and is thus mechanically coupled to the transmitting component 2.

In this embodiment, the locking receptacle 16 for the molded part 21 of the locking means configured as a spring U-clamp 12 is arranged on a selector frame 10 or shaped on as an autonomous molded part.

In FIG. 3, an arrow indicates a force designated by the reference abbreviation F_{K} that can act on the gearshift cable 23 and that can occur as an impact force during the operation of a motor vehicle having such a selector device. Such impact forces F_{K} can cause the locking means 11 to become disengaged from the locking receptacle 16 when the actuating lever 1 is in the first shift gate, and thus the entire transmitting component 2 can be detached from where it is affixed. In order for the locking means 11 to be securely held by the locking receptacle 16 when the actuating lever 1 is in the second shift gate and thus when the transmitting component 2 is securely affixed, it is provided for the locking means 11 to have a spring element that, in this case, is configured as a spring tongue 12 at whose free end a molded part 21 is arranged, whereby the spring tongue 12 is subjected to a restoring force. In this context, the restoring force is directed in such a way that it is directed counter to the direction of movement of the actuating lever 1 during the shifting from the second shift gate into the first shift gate. Moreover, this restoring force is dimensioned in such a way that it autonomously and compulsorily returns the molded part 21 to a target position of the locking receptacle 16 via surfaces 22 of the locking receptacle 16 when impact forces F_{K} that have acted on the gearshift cable 23 have caused the molded part 21 to become detached from the locking receptacle 16. Here, the surfaces 23 converge conically and interact with corresponding surfaces of the molded part 21 in such a way that they slide on the surfaces 23 due to the restoring force until the molded part 21 has reached its target position in the end centering means 25 and the transmitting component 2 is securely affixed. In order to prevent the molded part 21 or the locking means 11 from becoming completely detached from the locking receptacle 16 when a force is exerted by the gearshift cable 23, a relieving centering means 26 is provided inside the locking receptacle 16. Here, the relieving centering means 26 is configured to be essentially heart-shaped, and it extends conically towards the end centering means 25 as well as conically away from the end centering means 25.

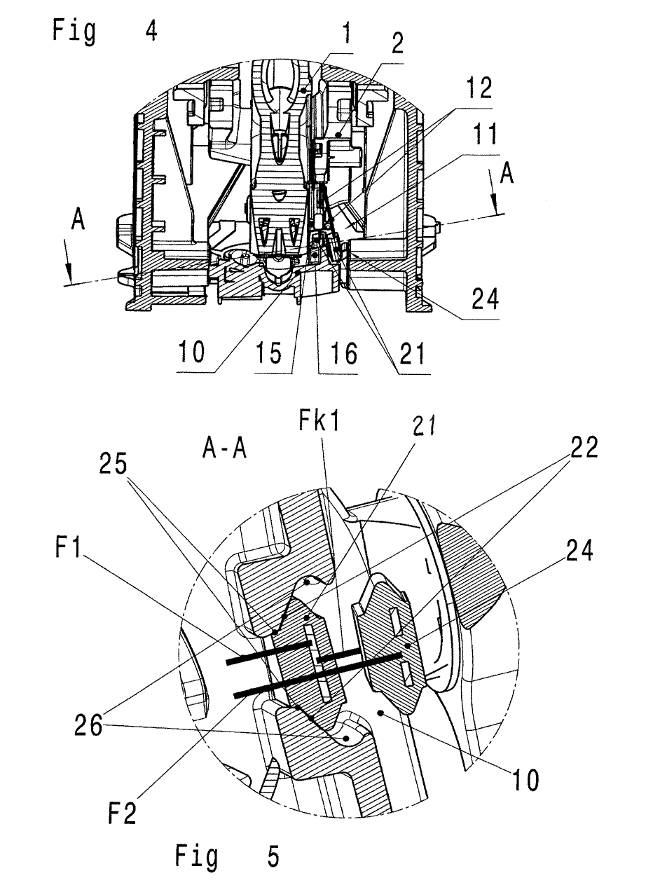

FIG. 5 shows the selector frame 10 of FIGS. 3 and 4 in a top view along a section A-A of FIG. 4. One can clearly see the surfaces 22 on which, in response to a restoring force F₁, the molded part 21 of the locking means 11 can slide into a target position in the locking receptacle 16, configured as a conical end centering means 25. In FIG. 5, the component of an impact force F_{K} acting on the gearshift cable 23 is indicated as F_{K1}, and it can cause the molded part 21 of the locking means 11 to become detached from the locking receptacle 16 or from the end centering means.

In this context, the reference numeral 24 indicates a position of the molded part 21 which it assumes when the actuating lever 1 has been shifted into the first shift gate. Here, the locking means 11 is held in the position 24 by means of an actuating projection 15, as shown in FIG. 4. When the molded part 21 is in this position 24, the transmitting component 2 is mechanically coupled to the actuating lever 1, as is likewise shown in FIG. 4.

In FIG. 5, F₂ indicates the force component of the restoring force of the locking means 11 which acts when the locking means 11 is held in the position 24 by means of the actuating projection 15.

In FIG. 4, as already mentioned, the actuating lever 1 is arranged in the first shift gate. Here, the actuating lever 1 is mechanically coupled to the transmitting component 2. In order to once again illustrate an idea of the invention, FIG. 4 shows the locking means, on the one hand, with the molded part 21 in the position 24, as corresponds to the positioning of the actuating lever 1 in this depiction of FIG. 4. On the other hand, however, the molded part 21, which is likewise configured as a separate molded part, is also depicted in FIG. 4 in such a way that it is accommodated in the locking receptacle 16, which actually corresponds to the position of the actuating lever 1 in the second shift gate (not shown here in FIG. 4). In this position, the molded part 21 with its surfaces, which are configured to slide on the surfaces 23 of the locking receptacle 16, is in contact with corresponding conical end centering means 25.

### LIST OF REFERENCE NUMERALS

1 actuating lever
2 transmitting component
3 pivot axis
4 coupling point
5 shifting axis
6 first projection
7 first recess
8 second projection
9 second recess
10 selector frame
11 locking means
12 spring tongue
13 first end
14 second end
15 actuating projection
16 locking receptacle
17 first pivot arm
18 second pivot arm
19 U-clamp
20 openings
21 molded part
22 surface
23 gearshift cable
24 position
25 conical end centering means
26 conical relieving centering means
F_{K} impact force
F_{K1} component of the impact force
F₁ restoring force
F₂ restoring force
A-A section

1. A selector device for a motor vehicle transmission, comprising
an actuating lever (1)
a) that is adapted to can be selectively shifted into a first shift gate in which the lever is mechanically coupled to a transmitting component (2) in order to actuate a gearshift cable (23) or a gearshift linkage, or
b) that is adapted to be selectively shifted into a second shift gate in which it is uncoupled from the transmitting component (2),
wherein the transmitting component (2) is movably supported, and
wherein a locking means (11) configured as a spring element is provided,
c) with which the transmitting component (2) is adapted to be secured in such a way that the spring element does not exert any force on the gearshift cable (23) or on the gearshift linkage as long as the actuating lever (1) has been shifted into the second shift gate, and
d) for which the locking means is accommodated in a locking receptacle (16) when the actuating lever (1) is in the second shift gate,
wherein
the locking receptacle (16) has an end centering means (25) in which the locking means configured as a spring element, along with its molded part (21), is accommodated in a target position when the actuating lever (1) is in the second shift gate, wherein the locking receptacle (16) also has a relieving centering means (26), wherein the locking receptacle (16) or the relieving centering means (26) or the end centering means have surfaces (22) on which the molded part (21) is adapted to be autonomously shifted into a target position by a restoring force that is directed towards the end centering means (25) and that is exerted onto the locking means (11) when the actuating lever (1) is in the second shift gate, and wherein the surfaces of the relieving centering means (26) extend conically towards the end centering means (25) as well as conically away from the end centering means (25), and wherein the cross section of the molded part (21) is configured with corresponding surfaces in such a way that, when it is moved out of the end centering means (25), it can be accommodated with a positive fit, at least in some areas, in the relieving centering means (26).

2. The selector device according to claim 1, wherein the locking means (11) configured as a spring element has a spring tongue (12) onto whose free end the molded part (21) is shaped, said shape corresponding to the shape of the locking receptacle (16) in the area of the end centering means (25).

3. The selector device according to claim 1, wherein the locking receptacle (16) or the relieving centering means (26) or the end centering means have surfaces (22) on which the molded part (21) can be autonomously shifted into a target position by a restoring force that is directed towards the end centering means (25) and that is exerted onto the locking means (11) when the actuating lever (1) is in the second shift gate.

4. The selector device according to claim 3, wherein the actuating lever (1) has an actuating projection (15) with which the locking means (11), along with its molded part (21), can be disengaged from the locking receptacle (16) when the actuating lever (1) is shifted from the second shift gate into the first shift gate.

5. The selector device according to claim 1, wherein either the locking means (11) is arranged on the transmitting component (2) and the locking receptacle (16) is arranged on a selector frame (10) or on a selector housing, or else the locking means (11) is arranged on a selector frame (10) or on a selector housing and the locking receptacle (16) is arranged on the transmitting component (2).

6. The selector device according to claim 1, wherein the gearshift cable (23) or the gearshift linkage is arranged on the transmitting component (2).

7. The selector device according to claim 1, wherein the transmitting component (2) has a first pivot arm (17) and a second pivot arm (18), wherein the actuating lever (1) is arranged between the first pivot arm (17) and the second pivot arm (18), and wherein the first pivot arm (17) and the second pivot arm (18) are firmly connected to each other by means of a connecting piece.

8. The selector device according to claim 1, wherein the capability of the transmitting component (2) to pivot is blocked when the actuating lever (1) has been shifted into the second shift gate, and the capability of the transmitting component (2) to pivot is made possible when the actuating lever (1) has been shifted into the first shift gate.

9. A motor vehicle transmission having the selector device according to claim 1.

10. A motor vehicle having a transmission having the selector device according to claim 2.

11. A selector device for a motor vehicle transmission, comprising:
an actuating lever that is adapted to be selectively shifted into a first shift gate or into a second shift gate, said actuating lever being mechanically coupled to a transmitting component in order to actuate a gearshift cable or a gearshift linkage when in the first shift gate, and said actuating lever being uncoupled from the transmitting component when in the second shift gate;
a spring element to lock the actuating lever, said spring element having a molded part associated therewith; and
a locking receptacle, said spring element being accommodated in the locking receptacle when the actuating lever is in the second shift gate, and said spring element secured with a movably supported transmitting component so that the spring element does not exert any force on the gearshift cable or on the gearshift linkage so long as the actuating lever has been shifted into the second shift gate, said locking receptacle having an end centering means in which the spring element, along with the molded part associated with the spring element, are accommodated in a target position when the actuating lever is in the second shift gate, and wherein the locking receptacle has a relieving centering means, and wherein the locking receptacle or the relieving centering means or the end centering means have surfaces on which the molded part associated with the spring element is autonomously shifted into a target position by a restoring force that is directed towards the end centering means and that is exerted onto the locking means when the actuating lever is in the second shift gate, with the surfaces of the relieving centering means extending conically towards the end centering means as well as extending conically away from the end centering means; and
wherein the molded part associated with the spring element is configured such that at least a portion thereof fits within the relieving centering means when said molded part is moved out of the end centering means.
